(19) United States
(12) Patent Application Publication
(10) Pub. No.: US 2013/0258199 A1
(43) Pub. Date: Oct. 3, 2013

(54) VIDEO PROCESSOR AND VIDEO PROCESSING METHOD

(71) Applicant: KABUSHIKI KAISHA TOSHIBA, Tokyo (JP)

(72) Inventor: Yasuhiro OOKAWARA, Kunitachi-shi (JP)

(73) Assignee: KABUSHIKI KAISHA TOSHIBA, Tokyo (JP)

(21) Appl. No.: 13/711,976

(22) Filed: Dec. 12, 2012

(30) Foreign Application Priority Data
Mar. 29, 2012 (JP) 2012-078369

(51) Int. Cl. H04N 9/73

(52) U.S. Cl. CPC H04N 9/735
USPC 348/655

(57) ABSTRACT

In one embodiment, there is provided a video processor. The video processor includes: a storage configured to store characteristic data of a display; a generator configured to generate target tristimulus values based on the characteristic data and a luminance value at a first gradation level and to generate correction values based on the target tristimulus values; and a processor configured to correct a color temperature of at least an interval between a high-gradation portion and a low-gradation portion based on the correction values.

### CROSS-REFERENCE TO RELATED APPLICATION

This application claims priority from Japanese Patent Application No. 2012-078369, filed on Mar. 29, 2012, the entire contents of which are hereby incorporated by reference.

### BACKGROUND

1. Field

Embodiments described herein relate to video processor and a video processing method.

2. Description of Related Art

A white point adjuster is known which can set a color temperature of a white point of a highest gradation or luminance level and keep the color temperatures of respective gradation levels approximately constant. In many of general liquid crystal displays used in personal computers etc., the maximum luminance value of blue is lower than the maximum luminance values of red and green. Such liquid crystal displays have a problem that when the above kind of white point adjustment is performed, the outputs of red and green are lowered so as to be suitable for the output of blue, as a result of which the luminance of a highest gradation level is reduced and hence displayed video is made darker.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a general functional block diagram of a personal computer according to an embodiment;

FIG. 2 is a block diagram of a conversion table generator 12 used in the embodiment;

FIG. 3 shows example characteristic data of a display used in the embodiment;

FIGS. 4A and 4B are schematic graphs illustrating effects of the correction according to the embodiment;

FIG. 5 is a graph showing the characteristic of a conversion table Bout[n] used in the embodiment;

FIG. 6 illustrates B-spline interpolation which is employed in the embodiment;

FIG. 7 is a graph showing the characteristic of a conversion table Bout[n] as processed by a table replacement processor 26 used in the embodiment; and

FIG. 8 is a block diagram showing the configuration of the personal computer according to the embodiment.

### DETAILED DESCRIPTION

According to exemplary embodiments of the present invention, there is provided a video processor. The video processor includes: a storage configured to store characteristic data of a display; a generator configured to generate target tristimulus values based on the characteristic data and a luminance value at a first gradation level and to generate correction values based on the target tristimulus values; and a processor configured to correct a color temperature of at least an interval between a high-gradation portion and a low-gradation portion based on the correction values.

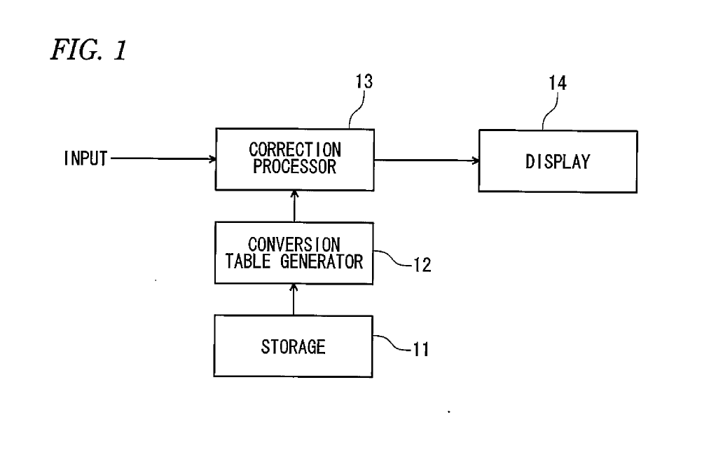

An embodiment will be hereinafter described with reference to FIGS. 1-8.

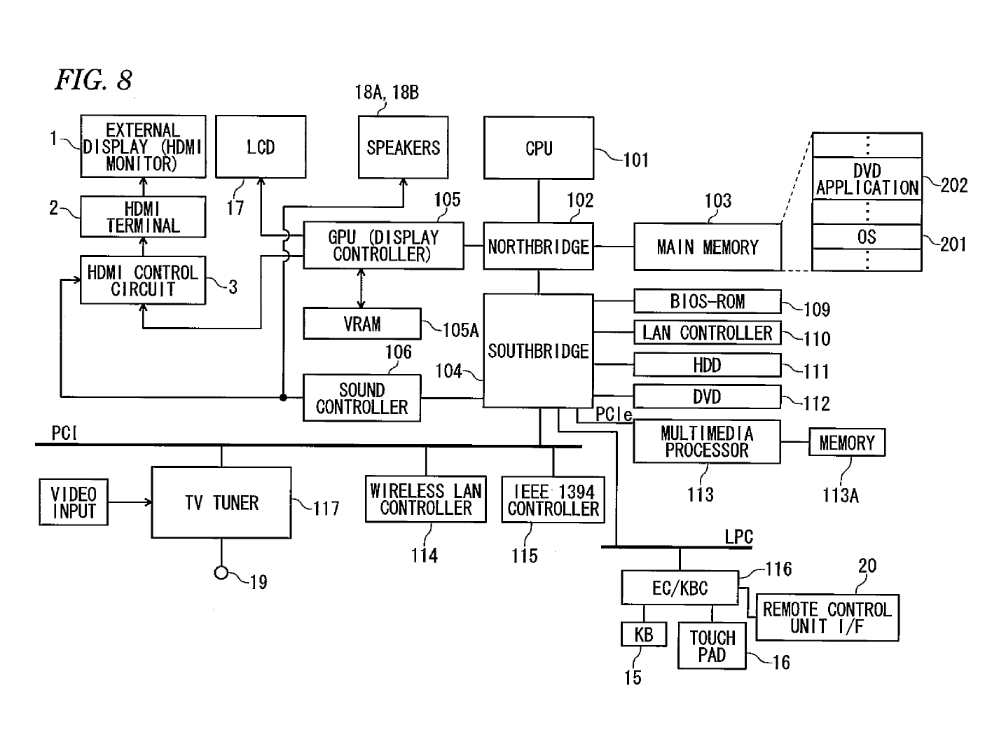

First, the configuration of a notebook portable personal computer 10 as an example video processor (reproducing apparatus) according to the embodiment will be described with reference to FIG. 8.

The personal computer 10 can record and reproduce video content data (audio-visual (AV) content data) such as broadcast program data or video data that is input from an external apparatus. That is, the personal computer 10 has a television (TV) function for enabling viewing and recording of broadcast program data that is broadcast as a TV broadcast signal. For example, this TV function is realized by a TV application program that is installed in the personal computer 10 in advance. The TV function includes a function of recording video data that is input from an external AV apparatus and a function of reproducing recorded video data or broadcast program data.

Next, the system configuration of the personal computer 10 will be described with reference to FIG. 8. As shown in FIG. 8, the personal computer 10 is equipped with a CPU 101, a northbridge 102, a main memory 103, a southbridge 104, a graphics processing unit (GPU) 105, a video memory (VRAM) 105A, a sound controller 106, a BIOS-ROM 109, a LAN controller 110, a hard disk drive (HDD) 111, a DVD drive 112, a multimedia processor 113, a memory 113A, a wireless LAN controller 114, an IEEE 1394 controller 115, an embedded controller/keyboard controller IC (EC/KBC) 116, a TV tuner 117, etc.

The CPU 101 is a processor which controls operations of the personal computer 10. The CPU 101 runs an operating system (OS) 201 and various application programs such as a DVD application program 202 which is software for reproducing a DVD that is mounted in the DVD drive 112. The CPU 101 also rims a BIOS (basic input/output system) which is stored in the BIOS-ROM 109. The BIOS is programs for hardware control.

The northbridge 102 is a bridge device which connects a local bus of the CPU 101 to the southbridge 104. The northbridge 102 incorporates a memory controller for access-controlling the main memory 103. The northbridge 102 also has a function of performing a communication with the GPU 105 via, for example, a serial bus that complies with the PCI Express standard.

The GPU 105 is a display controller which controls an LCD 17 which is used as a display monitor of the personal computer 10. A display signal generated by the GPU 105 is sent to the LCD 17. The GPU 105 can also send a digital video signal to an external display 1 via an HDMI control circuit 3 and an HDMI terminal 2.

The HDMI terminal 2 is an external display connection terminal. The HDMI terminal 2 can send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls the individual devices on an LPC (low pin count) bus and the individual devices on a PCI (peripheral component interconnect) bus. The southbridge 104 incorporates an IDE (integrated drive electronics) controller for controlling the HDD 111 and the DVD drive 112. The southbridge 104 also has a function of performing a communication with the sound controller 106.

The multimedia processor 113 is connected to the southbridge 104 via, for example, a serial bus that complies with the PCI Express (PCIe) standard.

The memory 113A is used as a work memory of the multimedia processor 113. The multimedia processor 113 is configured such that an MPEG-2 decoding circuit for decoding compression-coded video data, four processing cores, etc. are incorporated in a single chip. Each processing core has high media processing ability and a large performance-power consumption ratio. When the DVD application program 202 reproduces a DVD, the MPEG-2 decoding circuit decodes the video data of the DVD. The four processing cores perform interlace-progressive conversion (IP conversion) on video data having 720×480 pixels as decoded by the decoding circuit. The four processing cores perform a number-of-pixels increasing conversion of converting video data having 720×480 pixels (SD image quality) into video data having 1,920×1,080 pixels (HD image quality). The number-of-pixels increasing conversion performed by the multimedia processor 113 uses a bi-cubic method (cubic convolution interpolation method (CC method)). A number-of-pixels increasing conversion using the bi-cubic method requires a large calculation amount. In the embodiment, the processing cores of the dedicated multimedia processor 113 which is separate from the CPU 101 are used as a backend processor and perform a number-of-pixels increasing conversion. Therefore, a number-of-pixels increasing conversion can be performed without increasing the load of the CPU 101.

The DVD application program 202 has a decoding module which is run by the CPU 101 to decode video data. When video data is decoded using the decoding module of the DVD application program 202 to display video data on the LCD 17, the resulting video data which has 720×480 pixels (SD image quality) is converted into video data having 1,920×1,080 pixels (HD image quality) by a number-of-pixels increasing conversion function of the GPU 105. The number-of-pixels increasing conversion function of the GPU 105 employs a hi-linear method which is lighter in processing load (smaller in calculation amount) and lower in image quality than the bi-cubic method (cubic convolution interpolation method).

The GPU 105 performs a number-of-pixels increasing conversion according to the bi-linear method in the case where the number of pixels of video data that is input to the GPU 105 is different from that of video data to be displayed on the LCD 17 or output from the HDMI terminal 2. The GPU 105 does not perform a number-of-pixels increasing conversion if the two numbers of pixels are identical.

A user can choose between decoding and number-of-pixels increasing conversion to be performed by the multimedia processor 113 and decoding and number-of-pixels increasing conversion to be performed by the combination of the decoding module of the DVD application program 202. Decoding and number-of-pixels increasing conversion performed by the multimedia processor 113 are called up-conversion by the multimedia processor 113.

The sound controller 106 is a sound source device, and outputs an audio data, which is to be played, to the speakers 18A and 18B or the HDMI control circuit 3.

The wireless LAN controller 114 is a wireless communication device which performs a wireless communication according to the IEEE 802.11 standard, for example. The IEEE 1394 controller 115 performs a communication with an external apparatus via a serial bus which complies with the IEEE 1394 standard.

The EC/KBC 116 is a one-chip microcomputer in which an embedded controller for power management and a keyboard controller for controlling a keyboard (KB) 15 and a touch pad 16 are integrated together. The EC/KBC 116 is configured to power on or off the personal computer 10 in response to a user manipulation of a power button. The EC/KBC 116 is also configured to communicate with a remote controller unit interface 20.

The TV tuner 117 is configured to receive broadcast program data that is broadcast as a TV broadcast signal, is connected to an antenna 19. The TV tuner 117 is implemented as a digital TV tuner configured to receive digital broadcast program data of ground-wave digital TV broadcast, for example. The TV tuner 117 is also configured to capture video data that is input from an external apparatus.

FIG. 1 is a general functional block diagram of the personal computer 10 according to the embodiment. The personal computer 10 includes a storage 11, a conversion table generator 12, a correction processor 13, and a display 14. Pieces of processing illustrated by FIGS. 1-7 and relating to the storage 11, the conversion table generator 12, and the correction processor 13 are performed by the GPU 105. The display 14 corresponds to the LCD 17 or the external display 1.

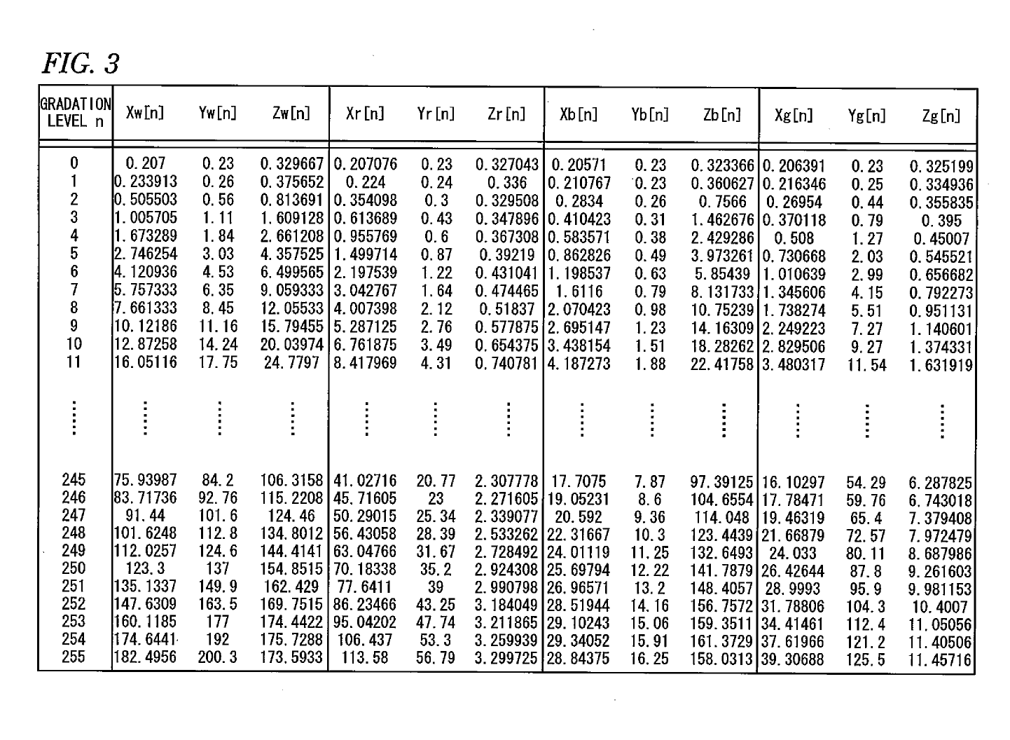

The storage 11 stores characteristic data shown in FIG. 3. The characteristic data are XYZ tristimulus values and are data that were obtained in advance by displaying characteristic measurement video signals on the display 14 and measuring them with an optical measuring instrument. The video signals are rgb video signals and denoted by (r, g, b). Tristimulus values Xw[n], Yw[n], and Zw[n] are ones that are measured when video signals (n, n, n) are displayed on the full screen of the display 14. Tristimulus values Xr[n], Yr[n], and Zr[n] are ones that are measured when video signals (n, 0, 0) are displayed on the full screen of the display 14. Tristimulus values Xg[n], Yg[n], and Zg[n] are ones that are measured when video signals (0, n, 0) are displayed on the full screen of the display 14. Tristimulus values Xb[n], Yb[n], and Zb[n] are ones that are measured when video signals (0, 0, n) are displayed on the full screen of the display 14. The number n is one of integers 0 to 255.

The conversion table generator 12 generates conversion tables for respective rgb video signals on the basis of the characteristic data that are held by the storage 11. A converted value when the r signal value is x is represented by Rout[x]. A converted value to be obtained when the r signal value is x is represented by Rout[x]. A converted value to be obtained when the g signal value is x is represented by Gout[x]. A converted value to be obtained when the b signal value is x is represented by Bout[x].

The correction processor 13 converts input video signals (r, g, b) into converted values (Rout[r], Gout[g], and Bout[b]) using the conversion tables generated by the conversion table generator 12, and supplies resulting signals to the display 14.

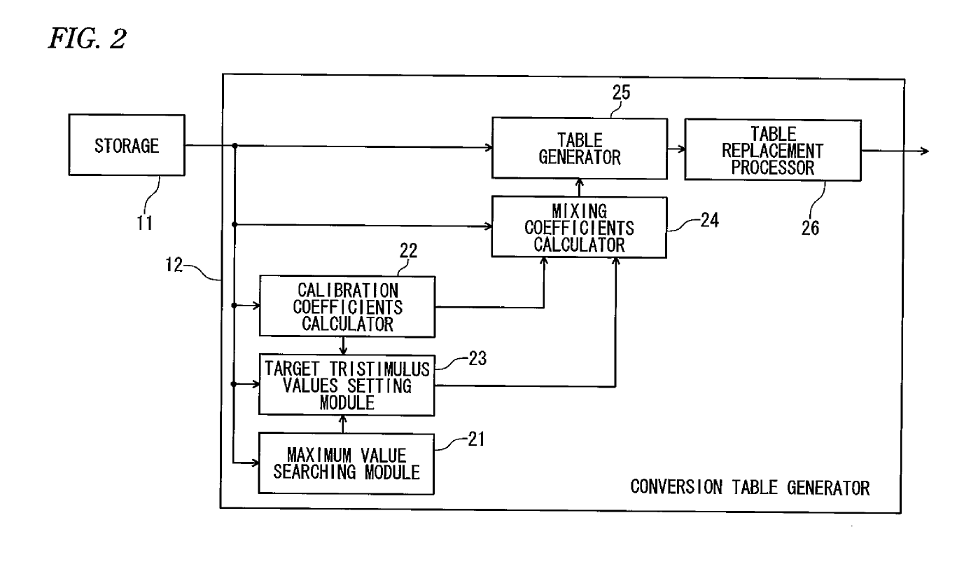

FIG. 2 is a block diagram of the conversion table generator 12. The conversion table generator 12 includes a maximum value searching module 21, a calibration coefficients calculator 22, a target tristimulus values setting module 23, a mixing coefficients calculator 24, a table generator 25, and a table replacement processor 26.

The maximum value searching module 21 extracts a maximum value from the characteristic data Yg[n] that are held by the storage 11. The maximum data taken out is represented by Yg_max (the maximum data is not necessarily equal to Yg[255]).

The calibration coefficients calculator 22 calculates calibration coefficients α[n], β[n], and γ[n] according to the following Equation (1):

$$[ \begin{matrix}α [ n ] \\ β [ n ] \\ γ [ n ]\end{matrix} ] = {[ \begin{matrix}Xr [ n ] & Xg [ n ] & Xb [ n ] \\ Yr [ n ] & Yg [ n ] & Yb [ n ] \\ Zr [ n ] & Zg [ n ] & Zb [ n ]\end{matrix} ]}^{- 1} [ \begin{matrix}Xw [ n ] \\ Yw [ n ] \\ Zw [ n ]\end{matrix} ] \qquad ( 1 )$$

In an ideal display, relationships Xw[n]=Xr[n]+Xg[n]+Xb[n], Yw[n]=Yr[n]+Yg[n]+Yb[n], and Zw[n]=Zr[n]+Zg[n]+Zb[n] hold. However, since these relationships do not hold in general displays, calibration coefficients α[n], β[n], and γ[n] need to be calculated. With the calibration coefficients α[n], β[n], and γ[n], relationships Xw[n]=α[n]Xr[n]+β[n]Xg[n]+γ[n]Xb[n], Yw[n]=α[n]Yr[n]+β[n]Yg[n]+γ[n]Yb[n], and Zw[n]=α[n]Zr[n]+β[n]Zg[n]+γ[n]Zb[n] hold.

The target tristimulus values setting module 23 calculates target tristimulus values Xtarget, Ytarget, and Ztarget according to the following procedure.

First, initial values are set. Ytarget is set at a predetermined value (e.g., 350). Xtarget and Ztarget are set at values that are calculated according to equations including Ytarget using chromaticity coordinates (x, y).

Then, intensity j is calculated according to the following Equation (2):

$$[ \begin{matrix}i \\ j \\ k\end{matrix} ] = {[ \begin{matrix}α [ 255 ] Xr [ 255 ] & β [ 255 ] Xg [ 255 ] & γ [ 255 ] Xb [ 255 ] \\ α [ 255 ] Yr [ 255 ] & β [ 255 ] Yg [ 255 ] & γ [ 255 ] Yb [ 255 ] \\ α [ 255 ] Zr [ 255 ] & β [ 255 ] Zg [ 255 ] & γ [ 255 ] Zb [ 255 ]\end{matrix} ]}^{- 1} [ \begin{matrix}Xtarget \\ Ytarget \\ Ztarget\end{matrix} ] \qquad ( 2 )$$

Then, using the thus-calculated intensity j, Yg[255]·j is compared with Yg_max. If Yg[255]·j≦Yg_max, the process is finished. If not, the process moves to a targets changing step.

In the target changing step, a constant a is subtracted from Ytarget. Xtarget and Ztarget are calculated again in the same manner as described above using the new Ytarget. The targets changing step is thus completed and intensity j is calculated again. The loop is executed until Yg[255]·j≦Yg_max is satisfied.

The mixing coefficients calculator 24 calculates mixing coefficients i[n], j[n], and k[n] according to the following Equation (3) in which the parameter gamma relates to what is called RGB gamma correction and is set at a value “2.2,” for example:

$$[ \begin{matrix}i [ n ] \\ j [ n ] \\ k [ n ]\end{matrix} ] = {[ \begin{matrix}α [ n ] Xr [ n ] & β [ n ] Xg [ n ] & γ [ n ] Xb [ n ] \\ α [ n ] Yr [ n ] & β [ n ] Yg [ n ] & γ [ n ] Yb [ n ] \\ α [ n ] Zr [ n ] & β [ n ] Zg [ n ] & γ [ n ] Zb [ n ]\end{matrix} ]}^{- 1} [ \begin{matrix}{Xtarget ( \frac{n}{255} )}^{gamma} \\ {Ytarget ( \frac{n}{255} )}^{gamma} \\ {Ztarget ( \frac{n}{255} )}^{gamma}\end{matrix} ] \qquad ( 3 )$$

The table generator 25 generates conversion tables Rout[n], Gout[n], and Bout[n] using the characteristic data that are held by the storage 11 and the mixing coefficients calculated by the mixing coefficients calculator 24. The table Rout[n] is a conversion table for an r signal; the conversion value is equal to Rout[n] when the gradation level of an r signal is equal to n. The table Gout[n] is a conversion table for a g signal, and the table Bout[n] is a conversion table for a b signal.

A conversion value Rout[n] is determined in the following manner. Xr[n]i[n] is calculated, and a value Xr[n] that is closest to the thus-calculated Xr[n]i[n] is found in the characteristic data shown in FIG. 3 and a corresponding gradation level is determined as a conversion value Rout[n]. A specific example is as follows. To determine a conversion value Rout[250], Xr[250]i[250] is calculated. If Xr[250]i[250] is equal to, say, 57.4, a value) Xr[248] is closest to it. Therefore, the conversion value Rout[n] is determined to be 248.

Conversion values Gout[n] and Bout[n] are determined in similar manners. That is, for Gout[n], Yg[n]j[n] is calculated and a value Yg[n] that is closest to it is found. For Bout[n], Zb[n]k[n] is calculated and a value Zb[n] that is closest to it is found. Conversion tables Rout[n], Gout[n], and Bout[n] which cover all the gradation levels are generated by the above-described method.

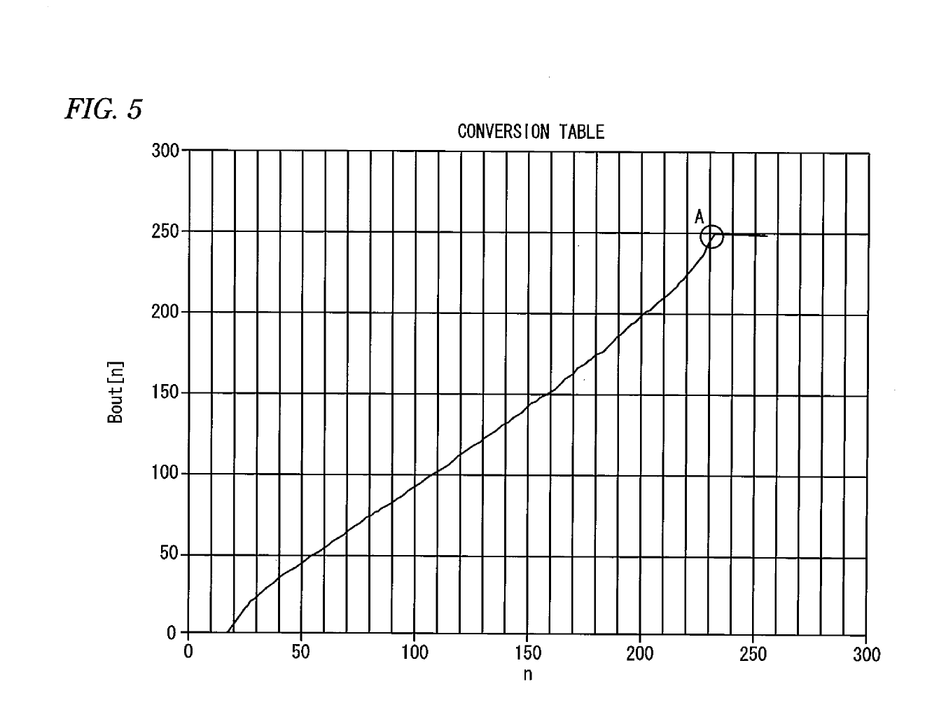

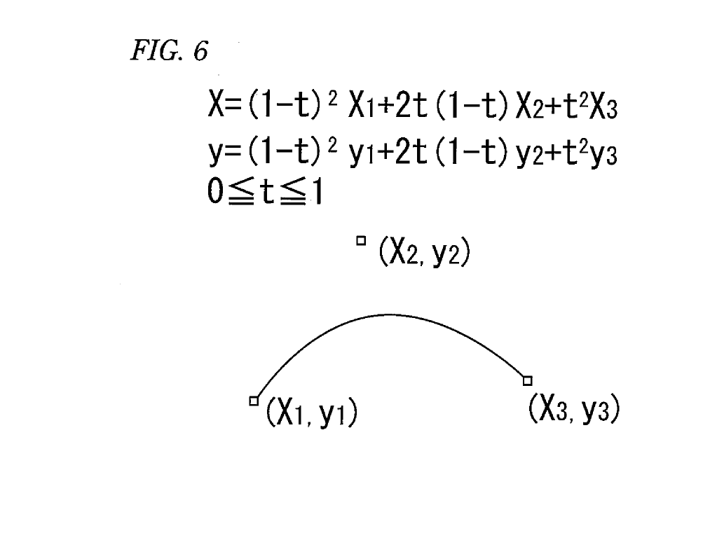

The table replacement processor 26 is configured to replace values of a high-gradation portion and a low-gradation portion of each of the conversion tables Rout[n], Gout[n], and Bout[n] generated by the table generator 25 with values generated by B-spline interpolation. FIG. 5 is a graph showing an example conversion table Bout[n] generated by the table generator 2. The conversion value is approximately constant in a low-gradation portion and a high-gradation portion (gradation levels higher than at point A (circled in FIG. 5)). These conversion values are replaced by values generated by B-spline interpolation. In the low-gradation portion, replacement values are calculated according to the following B-spline interpolation equations using values of predetermined three points which are, for example, (x₁, y₁)=(0, 0), (x₂, y₂)=(40, Bout[40]), and (x₃, y₃)=(50, Bout[50]). Values of the portion concerned (n≦x₃) of the conversion table Bout[n] are replaced by y values of the following B-spline interpolation equations (see FIG. 6):

x=(1−t)²x₁+2t(1−t)x₂+t²x₃

y=(1−t)²y₁+2t(1−t)y₂+t²y₃

where 0≦t≦1.

Similar pieces of processing are formed for the conversion tables Rout[n] and Gout[n]. In the case of the conversion table Rout[n], three points (x₁, y₁)=(0, 0), (x₂, y₂)=(40, Rout[40]), and (x₃, y₃)=(50, Rout[50]) are used. In the case of the conversion table Gout[n], three points (x₁, y₁)=(0, 0), (x₂, y₂)=(40, Gout[40]), and (x₃, y₃)=(50, Gout[50]) are used.

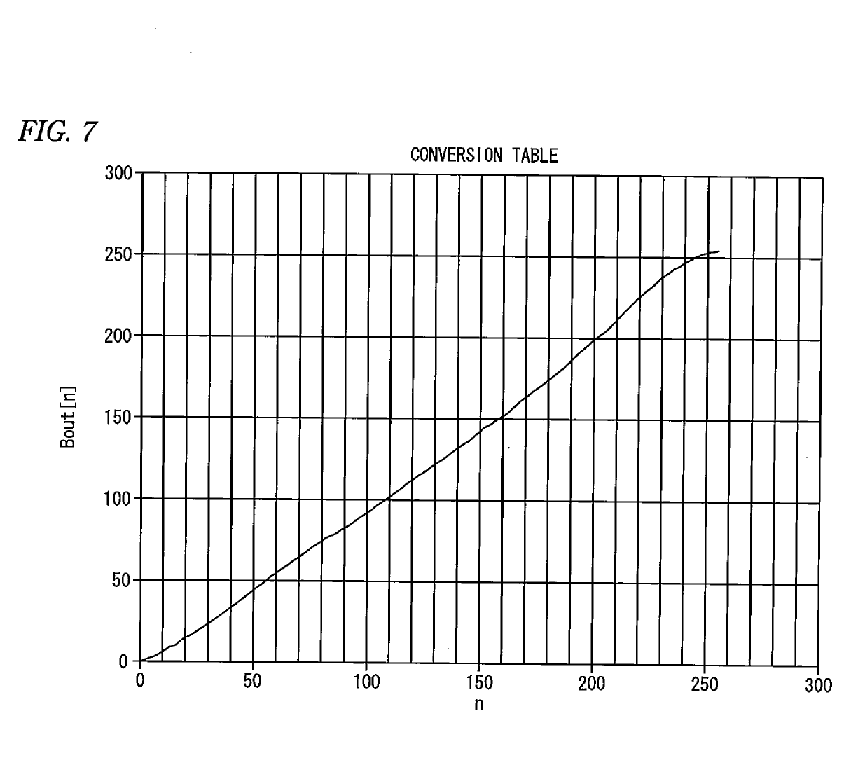

Processing of replacing values of a high-gradation portion of each of the conversion tables Rout[n] and Bout[n] with values generated by B-spline interpolation is performed. The replacement processing is performed only in a case that as shown in FIG. 5 the conversion value is saturated in the high-gradation portion. (That is, the conversion value remains approximately constant. Whether the conversion value is saturated or not is judged by checking whether or not the conversion value falls within a prescribed range for a prescribed variation of n. The same judgment method can be employed in the low-gradation portions.) Replacement values are calculated according to B-spline interpolation equations in the same manner as described above for the low-gradation portions. In the case of the conversion table Bout[n], the three points used are a saturation start point A (a, Bout[a]), point B (a−10, Bout[a−10]) (i.e., a point whose gradation level is lower than a by a prescribed value (e.g., 10)), and a maximum gradation point (255, 255). The values of the high-gradation portion (n is larger than or equal to a−10) of the conversion table Bout[n] are replaced by values calculated according to the B-spline equation. Similar processing is performed for the conversion table Rout[n]. FIG. 7 is a graph showing an example conversion table Bout[n] in which the low-gradation portion and the high-gradation portion shown in FIG. 5 are replaced by the table replacement processor 26.

The correction processor 13 converts the video signal using the conversion tables Rout[n], Gout[n], and Bout[n] that have been generated by the above process.

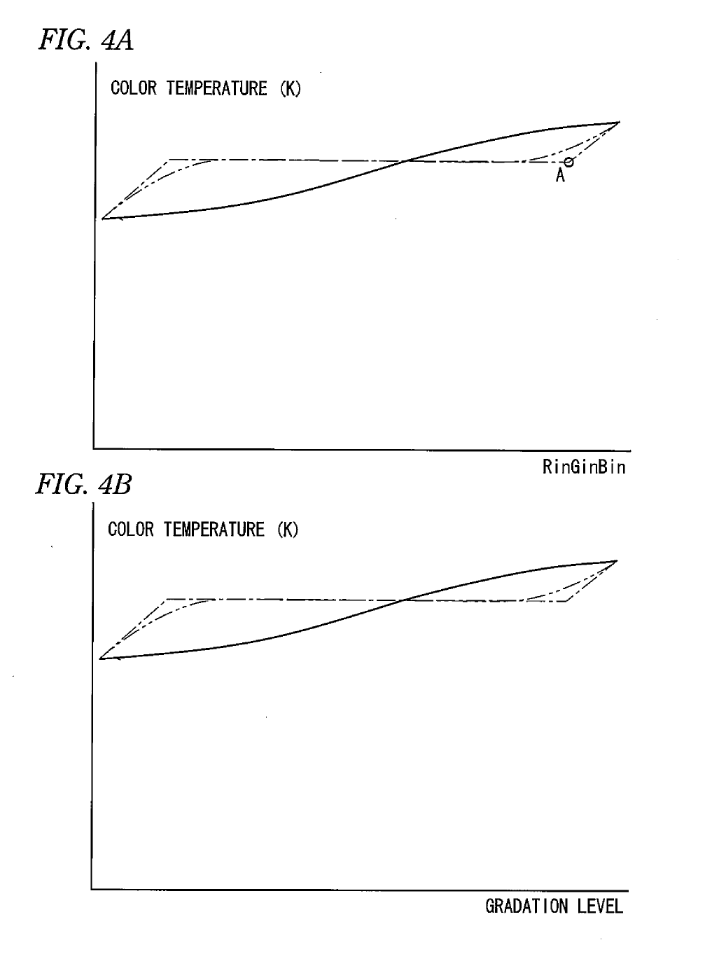

FIGS. 4A and 4B are schematic graphs illustrating effects of the correction according to the embodiment. The solid-line curve represents an original characteristic, and the curves drawn by a chain line and a two-dot chain line represent characteristics corresponding to the processing results shown in FIGS. 5 and 7, respectively. FIG. 4A is a graph showing a relationship between the color temperature and the gradation level in which point A corresponds to point A in FIG. 5. Interpolation is done additionally as seen from the two-dot-chain-line curve which corresponds to the characteristic of FIG. 7. FIG. 4B is a graph showing a relationship between the color temperature and the input. The interpolation in a low-gradation portion is reflected in FIG. 4B.

The maximum luminance is not reduced because correction data are generated using a green maximum output as a reference.

When saturation occurs in a high-gradation portion of generated correction data, correction data of that portion are replaced by data generated by B-spline interpolation. This provides an advantage that the color temperature varies gradually for a variation from medium gradations to high gradations.

The replacement of a low-gradation portion of generated correction data is replaced by data generated by B-spline interpolation prevents a phenomenon that a particular color is displayed brightly. This also provides an advantage that the color temperature varies gradually for a variation from low gradations to medium gradations.

The invention is not limited to the above embodiment itself and may be practiced such that constituent elements are modified in various manners without departing from the spirit and scope of the invention. For example, where a specific display to be used in an apparatus is determined, display characteristic data to be held by the storage 11 may be incorporated in the apparatus at the time of its manufacture. Where an external display is used and a communication can be performed with it, its display characteristic data may be input by communicating with it.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A video processor comprising:
a storage configured to store characteristic data of a display;
a generator configured to generate target tristimulus values based on the characteristic data and a luminance value at a first gradation level and to generate correction values based on the target tristimulus values; and
a processor configured to correct a color temperature of at least an interval between a high-gradation portion and a low-gradation portion based on the correction values.

2. The video processor of claim 1, wherein the generator comprises:
a replacement processor configured to generate replacement data through interpolation using the correction values and replace the correction values with the replacement data, when it is determined that at least a portion of the correction values is saturated.

3. The video processor of claim 2,
wherein the replacement processor is configured to replace the correction values with the replacement data in the high-gradation portion and/or the low-gradation portion.

4. The video processor of claim 2,
wherein the replacement processor is configured to generate the replacement data through B-spline interpolation.

5. The video processor of claim 1, further comprising:
a display configured to display an image, wherein the characteristic data of the display is obtained from the image.

6. A video processing method comprising:
storing a characteristic data of a display;
generating target tristimulus values based on the characteristic data and a luminance value at a first gradation level;
generating correction values based on the target tristimulus values; and
correcting a color temperature of at least an interval between a high-gradation portion and a low-gradation portion based on the correction values.
